(19) United States
(12) Patent Application Publication
(10) Pub. No.: US 2023/0194359 A1
(43) Pub. Date: Jun. 22, 2023

(54) DEVICE AND METHOD FOR DETECTING A VARIATION IN TEMPERATURE

(71) Applicant: AGRO-FORESTIER DU PUNTAL, MONTAUBAN (FR)

(72) Inventor: Fabrice COLETTO-TONICELLO, MONTAUBAN (FR)

(21) Appl. No.: 17/923,500

(22) PCT Filed: May 7, 2021
(86) PCT No.: PCT/FR2021/050783

§ 371 Date: Nov. 4, 2022

(30) Foreign Application Priority Data
May 7, 2020 (FR) 2004567

(51) Int. Cl. G01K 11/06

(52) U.S. Cl. CPC G01K 11/06; G01K 2207/04

(57) ABSTRACT

A control device for detecting a variation in temperature in an enclosure, includes a receptacle having at least one transparent surface portion including a solid solvent which is transparent and the solidification temperature of which corresponds to the maximum temperature threshold required in the enclosure, wherein a coloured composition having a different colour from the solvent has been partially diffused before the solvent is solidified.

### FIELD OF THE INVENTION

The present invention relates to a control device and to a method for detecting a variation in temperature in an enclosure. The present invention also relates to a method for preparing said control device. The present invention can be used, in particular, to detect a break in the cold chain in an enclosure, in particular a preservation enclosure.

### PRIOR ART

The cold chain is a critical step in the whole system of fresh and perishable products, in particular in the food or medical field. Strict respect to the cold chain is fundamental to human health, in particular in the fight against food poisoning, and for temperature-sensitive medicines (for example vaccines, insulin) during transportation and storage.

The entire cold chain is devoted to preventing both the multiplication and the activity of microbes in products that are temperature-sensitive and/or that contain “free water” or, in other words, water molecules which are not chemically bound to salt or sugar in the broad sense of the word. These microbes may spread all kinds of toxins, sometimes causing death.

Existing devices for detecting a break in the cold chain are disposable, single-use devices whose fate is coupled with food distribution. These markers have variable temperature sensitivity and can reproduce, with a certain degree of accuracy, the incremental temperature variations encountered during processing (transportation, storage).

These devices are based, in particular, on:
a chemical process: a thermochromic material changes colour after reaching a threshold temperature, and this change is irreversible. The available items include: FREEZEmarker®, TransTracker® by the Temptime company; WarmMark® by Evidencia; and Clearing-Point® and Thermostrip® by Hallcrest Inc;
a microbiological process: a lactic acid bacterium on a substrate will change colour when it reaches an excessive temperature, due to biotic reactions. After use, these latter devices are discarded. These devices include Topcryo® by the Cryolog company;
an electronic device: an RFID (radio-identification) tag contains a micro temperature recorder and will transfer its data when the reader is near the transponder. The accuracy can be improved with an enzyme: when the temperature varies, the enzyme modulates its electrical impedance, which is stored in the memory on the RFID motherboard chip. RFID temperature devices include Thermobouton® by the Thermo Track company.

Although all these devices are reliable in terms of the expected metrological accuracy, they are sometimes expensive and are not tamper-proof. Indeed, they are unable to prevent fraudulent labelling intended to hide a break in the cold chain process.

There is therefore a need for a device for detecting a break in the cold chain which is simple, reliable, tamper-proof and, moreover, affordable in comparison with the existing technical solutions for cold chain compliance detection.

### SUMMARY OF THE INVENTION

In the context of the present invention, the inventors have discovered a device which makes it possible to detect a variation in temperature, advantageously an increase in temperature, in an enclosure, without the risk of tampering and which is suitable for any temperature.

In particular, the inventors have prepared a device for detecting a variation in temperature, using Brownian motion in order to obtain three-dimensional shapes, such as spirals, by injecting a coloured composition into a solvent. After injecting the coloured composition into the solvent, followed by diffusion for a fixed time period depending on the diffusion speed of the coloured composition in the solvent, the process is stopped by freezing the solvent. Therefore, between the start of diffusion at t₀ and the total diffusion that would be reached at t_{f} if the coloured composition were uniformly distributed in the solvent, there is an infinite number of periods t evolving as a discrete variable, and a single specific molecular arrangement which produces a specific visible shape corresponds to each period t. Said specific visible shape is non-reproducible, which makes the device tamper-proof. Indeed, the contours of the specific visible shapes are generated randomly and are the result of the molecules colliding with each other due to the kinetic energy observed in the liquid phase of the solvent (Brownian motion).

In the context of the invention, the solvent is chosen depending on its solidification temperature, which must match the maximum temperature that the monitored enclosure can reach. When the maximum temperature of the enclosure is exceeded, the solidification temperature of the solvent is also exceeded and the solvent begins to melt. Therefore, the coloured composition can once again begin to diffuse by Brownian motion in the solvent, resulting in the modification of the specific visible shape obtained at time t₁ and the creation of a new specific visible shape.

According to a first aspect, the present invention relates to a control device for detecting a variation in temperature in an enclosure, characterised in that it comprises a receptacle having at least one transparent surface portion comprising a solid solvent which is advantageously transparent and the solidification temperature of which corresponds to the maximum temperature threshold required in the enclosure, wherein a coloured composition having a different colour from said solvent has been partially diffused before said solvent is solidified.

It is quite clear that the expression “solid solvent” comprised in the receptacle refers to a solvent that has been solidified after the coloured composition has diffused. Therefore, the expression “solid solvent” is also understood to mean “solidified solvent”.

The solvent is (like any liquid) sometimes in the liquid state and sometimes in the solid state, depending on the temperature, because it is the variation in temperature detected by the device of the invention that determines whether the solvent is solid or liquid. Therefore, during use, the device of the invention comprises the solvent in the solid state in which the colouring agent has been dissipated and “set” in a specific “3D profile” as a result of the solvent solidifying. The notion of a solid solvent therefore refers to a solidified solvent. It is the modification of this profile due to the modification from the solid state to the liquid state of the solvent that will be the marker of a thermal alteration or corruption of the system.

According to a second aspect, the present invention relates to a method for preparing a control device for detecting a variation in temperature in an enclosure, comprising the following steps:

a) Choosing a liquid solvent which is advantageously transparent in the solid state and the solidification temperature of which corresponds to the maximum temperature threshold required in the enclosure;
b) Choosing a coloured composition having a different colour from said solvent;
c) Introducing said liquid solvent into a receptacle having at least one transparent surface portion, said receptacle comprising at least one opening allowing the solvent and then the coloured composition to be introduced;
d) Eventually cooling said liquid solvent;
e) Introducing the coloured composition, and partially diffusing it in said liquid solvent, said coloured composition being a different colour from said solvent;
f) Cooling so as to solidify at least the liquid solvent in which the coloured composition has been partially diffused, so as to give the diffused coloured composition a specific shape that it can only keep by keeping the enclosure at a temperature lower than the solidification temperature of said solvent.

Therefore, when the device according to the invention is installed, the solvent has been solidified, and it is therefore a solid solvent.

According to a third aspect, the present invention relates to a method for detecting a variation in temperature in an enclosure, said method comprising the steps of:

i) Providing a device according to the invention or a device which can be obtained by the method according to the invention;
ii) Placing said device in the enclosure;
iii) Inspecting the specific shape of the coloured composition that is partially diffused in the solvent.

### DESCRIPTION OF THE INVENTION

### Definition

Within the meaning of the present invention, “variation in temperature” should be understood to mean an increase and/or a decrease in the temperature of an enclosure in relation to a determined threshold temperature. The variation may in particular be at least an increase in temperature beyond the threshold value, eventually followed by a decrease below the threshold value.

Within the meaning of the present invention, “translucent” should be understood to mean a body transmitting light in a diffuse manner and through which objects appear blurred. This is different from transparent bodies, which allow light to pass through and make it possible to distinguish objects, and from opaque materials which absorb or reflect the light rays. According to the present invention, the body may be translucent and coloured.

Within the meaning of the present invention, “transparent” should be understood to mean a body transmitting visible light by refraction and through which objects can be seen in sharp focus. According to the present invention, the body may be transparent and coloured.

Within the meaning of the present invention, “coloured composition” should be understood to mean a liquid, solid or gaseous composition, in particular a liquid or solid composition, which is soluble and miscible in a given solvent and which has a different colour from the solvent, either a colour visible in light or a colour visible under ultraviolet (UV) or infrared (IR) radiation. Advantageously, the colour of the coloured composition is visible in light or under UV radiation. Advantageously, the colour of the coloured composition contrasts significantly with the colour of the solvent, so as to ensure good optical acquisition.

In an alternative embodiment, the coloured composition has two or more colours and these two or more colours contrast significantly with the colour of the solvent. Therefore, the coloured solution may comprise, or I consist of, 2, 3 or 4 coloured solutions of different colours from the solvent, and which have not diffused into each other to the extent that they form a solution of uniform colour at the time step e) is carried out. There is therefore a coloured solution which, when introduced into and diffused in the liquid solvent, creates two, or three, or four diffusion spirals of different colours, which helps increase the degree of information and the detail. For example, if the coloured composition is in solid form, it may be a mixture of several crystals of different colours, which, when introduced into the solvent, dissolve and create spirals in several colours, different from the colour of the solvent.

Thus, after injection into a solvent, the soluble composition can diffuse in said solvent.

Within the meaning of the present invention, “electrolytic solution” should be understood to mean a solution comprising a salt in water.

Within the meaning of the present invention, “salt” should be understood to mean an ionic compound composed of cations and anions forming a neutral product with no net charge. These ions may be either mineral (e.g., chloride Cl⁻) or organic (e.g., acetate CH₃—COO⁻), and monoatomic (e.g., fluoride F⁻) or polyatomic (sulphate SO₄²⁻).

Within the meaning of the present invention, “isothermal packaging” should be understood to mean a packaging that can keep products cold (+2/+8° C.), frozen (−18/−20° C.) or indeed at a so-called “ambient” temperature (+15/+25° C.).

Within the meaning of the present invention, “visible light” should be understood to mean the part of the electromagnetic spectrum that is visible to humans, in particular in the vacuum wavelength range between 380 and 780 nm.

Within the meaning of the present invention, “ultraviolet (UV) radiation” should be understood to mean electromagnetic radiation with a wavelength shorter than that of visible light, but longer than that of X-rays. UV rays can only be observed indirectly, either by fluorescence, or by using specialised detectors. UV radiation emits, in particular, in the wavelength range between 100 and 400 nm.

Within the meaning of the present invention, “infrared (IR) radiation” should be understood to mean electromagnetic radiation with a wavelength longer than that of visible light, but shorter than that of microwaves. IR radiation emits, in particular, in the wavelength range between 780 nm and 1 mm.

In the context of the invention, a coloured composition having a different colour from the solvent used is partially diffused in the solvent before said solvent is solidified.

In the context of the present invention, “partially diffused composition” should be understood to mean a composition that is not totally diffused in the solvent. Thus, in the device according to the invention, a three-dimensional coloured shape appears in the solid solvent. As previously disclosed, the expression “solid solvent” refers to the solidified solvent. This three-dimensional shape corresponds to the coloured composition which has been partially diffused in the solvent before solidification and which is therefore set in the solid solvent (or solidified solvent). If total diffusion had taken place, the device would have a uniform colour and no specific shape would be visible.

Advantageously, the coloured composition is a miscible liquid solution which is miscible in the solvent or a soluble solid which is soluble in the solvent. Advantageously, the colouring agent of the coloured composition is a food colour. The expression “food colour” should be understood in this instance within the meaning of European Directive 94/36/EC, which thus defines food colours as substances that add or restore colour to foodstuffs. This may mean natural constituents of foodstuffs or other natural sources which are not normally consumed as food per se, and are not habitually used as characteristic ingredients in food.

“Miscible liquid solution” should be understood, within the meaning of the invention, to mean a liquid solution which, within a given temperature range, can mix with the liquid solvent in order to produce a uniform liquid solution. Advantageously, the miscible liquid solution is a solution prepared with a food colour. The miscibility temperature range advantageously includes the solidification temperature of the solvent so that the coloured composition can diffuse in the solvent as soon as the latter begins to melt.

Similarly, “soluble solid” should be understood, within the meaning of the invention, to mean a solid composition, for example in the form of powder, granules or a compacted tablet, which, within a given temperature range, can dissolve with the liquid solvent in order to produce a uniform liquid solution. Advantageously, the soluble solid is a food colour. The solubility temperature range advantageously includes the solidification temperature of the solvent so that the coloured composition can diffuse in the solvent as soon as the latter begins to melt.

In the context of the present invention, the diffusion of the coloured composition in the solvent depends in particular on the viscosity of the coloured composition. Indeed, the higher the viscosity, the lower the diffusion speed. When the solvent melts, the coloured composition will therefore diffuse more slowly and a brief decrease in temperature may not be detected. On the other hand, the lower the viscosity, the higher than diffusion speed. Thus, when preparing the device, it may be difficult to solidify the solvent before total diffusion of the coloured composition takes place. Therefore, the coloured composition advantageously has a viscosity of between 1 and 1000 mPa·s, at ambient temperature (i.e., approximately 20° C.), in particular between 1 and 500 mPa·s, and more particularly between 1 and 250 mPa·s.

### Control Device for Detecting a Variation in Temperature in an Enclosure

The present invention relates to a control device for detecting a variation in temperature in an enclosure, characterised in that it comprises a receptacle having at least one transparent surface portion comprising a solid solvent which is advantageously transparent and the solidification temperature of which corresponds to the maximum temperature threshold required in the enclosure, wherein a coloured composition having a different colour from said solvent has been partially diffused before said solvent is solidified. As previously disclosed, the expression “solid solvent” refers to the solidified solvent.

According to the invention, the device is suitable for detecting a variation in temperature in an enclosure, advantageously for detecting an increase in the temperature.

In the context of the invention, the increase in temperature may eventually be followed by a decrease in temperature. In this context, the temperature of the enclosure may increase, for example as a result of a transient technical fault in the temperature maintenance system, before decreasing to once more reach the initial temperature of the enclosure.

Advantageously, in the context of the invention, the variation in temperature characterises a break in the cold chain. Thus, the device according to the invention is advantageously a device for detecting a break in the cold chain.

Advantageously, the device according to the invention allows a variation in temperature of 1° C. or less to be detected.

Advantageously, the device according to the invention allows an increase in temperature of 1° C. or less to be detected.

In the context of the present invention, the enclosure is advantageously a preservation enclosure, advantageously for preserving temperature-sensitive products.

Advantageously, the enclosure is a primary, secondary or tertiary packaging, such as an isothermal packaging or a transport container such as a sea, air, road or space transport container; a transport facility such as a refrigerated lorry or a refrigerated trolley; a handling facility such as a clean room; or a storage facility such as a refrigerator, a cold room or a freezer.

According to the invention, the maximum temperature that the monitored enclosure can reach determines the choice of solvent. Indeed, the solid solvent must begin to melt as soon as the maximum temperature of the enclosure is exceeded, thus allowing the diffusion of the coloured composition to resume in the solvent by Brownian motion.

Depending on the product, standards set the temperature limits and the tolerances for exceeding them. For example, many fresh food products need to be kept at temperatures of between +2° C. and +8° C.; fresh fish needs to be kept at temperatures of between 0° C. and +2° C.; and frozen products need to be kept at temperatures below −18° C. The problems of compliance to the cold chain also apply to pharmaceutical products (vaccines, blood products, transplant materials, etc.). The maximum temperature then depends on each pharmaceutical product.

Therefore, in the device according to the invention, the solvent advantageously has a solidification temperature less than or equal to +25° C., advantageously less than or equal to 20° C., more advantageously less than or equal to +15° C., more advantageously less than or equal to +8° C., even more advantageously less than or equal to +5° C., even more advantageously less than or equal to +2° C., and even more advantageously less than or equal to 0° C.

In the device according to the invention, the solvent advantageously has a solidification temperature less than or equal to −18° C.

Advantageously, in the device according to the invention, the solvent has a solidification temperature of between −18° C. and +25° C., advantageously between −18° C. and +20° C., more advantageously between −18° C. and +15° C., and more advantageously between −18° C. and +8° C.

In the context of frozen products, in the device according to the invention, the solvent advantageously has a solidification temperature of between −18° C. and 0° C., and more advantageously between −18° C. and −6° C.

In the context of refrigerated products, in the device according to the invention, the solvent advantageously has a solidification temperature of between 0° C. and +25° C., advantageously between 0° C. and +20° C., more advantageously between 0° C. and +15° C., and more advantageously between 0° C. and +8° C.

Advantageously, in the device according to the invention, the solvent has an approximate solidification temperature equal to −18° C., 0° C., +2° C., +5° C., +8° C., +15° C., +20° C., or +25° C.

According to the present invention, the solvent is advantageously transparent in order to allow sharp optical acquisition of the visible shape formed by the coloured composition diffused in the solvent once solidified. Therefore, according to the present invention, the solvent is advantageously chosen from all solvents that are transparent in the solid state and that have a solidification temperature corresponding to the maximum temperature threshold required in the enclosure to be monitored.

The solvent may not be transparent in the solid state and, in such a scenario, the solute should be left to diffuse until the diffusion spirals touch or are flush with the transparent surface and create singular points there. The definition will be less detailed than with a transparent solvent giving singular points in 3D, but the 2D “signature” will be just as reliable and usable.

It is not possible to give a definition of the chemical class of a suitable solvent because it is its solidification temperature which will determine its suitability as a solvent, rather than its chemical class alone. Nevertheless, some can be cited by way of non-limiting illustrative examples.

Advantageously, the solvent is chosen from water, hydrocarbons, an oil, an alcohol, an aqueous electrolytic solution, and their miscible mixtures.

Advantageously, of the hydrocarbons, the following can be cited: cyclohexane, benzene, xylene, and halogenated hydrocarbons such as 1,2-dichlorobenzene or carbon tetrachloride.

Advantageously, of the vegetable or plant oils, rapeseed oil, corn oil, olive oil and fish oils can be cited, used alone or in mixtures.

Advantageously, of the alcohols, the following can be cited: 1-octanol and ethylene glycol.

Advantageously, of the aqueous electrolytic solutions, the following can be cited: water/NaCl or water/MgCl solutions, for example. In the case of electrolytic solutions, and in particular water/NaCl solutions, the concentration of salt (for example NaCl) in the solution influences the solidification temperature. Therefore, a water/NaCl solution comprising 20% NaCl will have a solidification temperature of −20° C. A water/NaCl solution comprising 22% NaCl will have a solidification temperature of −19.2° C. A person skilled in the art knows how to adjust the concentration of salt in order to obtain the required solidification temperature while avoiding saturation of the solution with salt, which would lead to turbidity and therefore a lack of transparency. This type of solvent is therefore particularly advantageous in the context of the invention because it is economical and allows a specific solidification temperature to be chosen without being constrained by a restricted solvent list.

Advantageously, the solvent is chosen from the solvents cited in table 1 below, alongside their solidification/melting temperature.

TABLE 1

| Solvent | Solidification/melting temperature | |
|---|---|---|
| Acetic acid | +16.2° | C. |
| 1-octanol | +15° | C. |
| p-Xylene | +12-+13° | C. |
| 1,4-dioxane | 11.8° | C. |
| Ethylene bromide | 9.974° | C. |
| Formic acid | +8° | C. |
| Cyclohexane | +6.5° | C. |
| Nitrobenzene | +5.7° | C. |
| Benzene | +5° | C. |
| Water | 0° | C. |
| Aniline | −5.96° | C. |
| Bromine | −7.1° | C. |
| Ethylene glycol | −12.9° | C. |
| Benzonitrile | −13° | C. |
| 1,2-dichlorobenzene | −18 to −15° | C. |
| 78/22 water/NaCl solution | −19.2° | C. |
| 80/20 water/NaCl solution | −20° | C. |
| Carbon tetrachloride | −23° | C. |

In the context of the invention, the receptacle of the device is designed to receive the liquid solvent which will subsequently be solidified, and the coloured composition. Therefore, said receptacle comprises at least one opening allowing the solvent and then the coloured composition to be introduced.

According to the invention, the receptacle may be in any shape and made from any material. Advantageously, the receptacle comprises at least one planar surface, more advantageously at least 2 planar surfaces, and more advantageously at least 3 planar surfaces. Advantageously, all of the surfaces of the receptacle are planar. Indeed, in the context of the invention, the more planar surfaces the receptacle has, the more accurate the analysis of the device, because it is carried out in several planes.

According to the invention, the receptacle must have at least one transparent surface portion. Advantageously, the receptacle comprises at least two surfaces having at least one transparent portion. More advantageously, the receptacle comprises at least three surfaces having at least one transparent portion. Particularly advantageously, the receptacle is totally transparent. According to the invention, the more surfaces with at least one transparent portion the receptacle has, the more accurate the analysis of the device, because it is carried out in several planes.

The choice of the coloured composition used in the device according to the invention is determined depending on the choice of the solvent used, and in particular the solidification temperature of this solvent. Advantageously, the coloured composition contains at least one food colour, or the colouring agent of this coloured composition is a food colour.

For example, if in the device according to the invention the solvent used is water, the coloured composition may be a liquid or solid composition, not colourless in light or visible under UV or IR radiation, miscible/soluble in a temperature range comprising the value 0° C., and having a viscosity of between 1 and 1000 mPa·s, at ambient temperature (i.e., approximately 20° C.), in particular between 1 and 500 mPa·s, and more particularly between 1 and 250 mPa·s.

An example of a device according to the invention is shown in FIG. 2. In this figure, the device comprises a three-dimensional shape (face (0,x,y) on the left and adjacent face (0,z,y) on the right). Said shape has been obtained by partial diffusion of an ink in the water and then solidification of the water.

### Method for Preparing the Device According to the Invention

The present invention further relates to a method for preparing a control device for detecting a variation in temperature in an enclosure, comprising the following steps:

a) Choosing a liquid solvent which is advantageously transparent in the solid state and the solidification temperature of which corresponds to the maximum temperature threshold required in the enclosure;
b) Choosing a coloured composition having a different colour from said solvent;
c) Introducing said liquid solvent into a receptacle having at least one transparent surface portion, said receptacle comprising at least one opening allowing the solvent and then the coloured composition to be introduced;
d) Eventually cooling said liquid solvent;
e) Introducing the coloured composition, and partially diffusing it in said liquid solvent, said coloured composition being a different colour from said solvent;
f) Cooling so as to solidify at least the liquid solvent in which the coloured composition has been partially diffused, so as to give the diffused coloured composition a specific shape that it can only keep by keeping the enclosure at a temperature lower than the solidification temperature of said solvent.

As indicated above, the choice of solvent (step a)) depends on the maximum temperature that the monitored enclosure can reach. The characteristics of the solvent are as defined above.

In particular, the solvent advantageously has a solidification temperature less than or equal to +25° C., advantageously less than or equal to 20° C., more advantageously less than or equal to +15° C., more advantageously less than or equal to +8° C., even more advantageously less than or equal to +5° C., even more advantageously less than or equal to +2° C., and even more advantageously less than or equal to 0° C.

Advantageously, the solvent has a solidification temperature less than or equal to −18° C.

Advantageously, the solvent has a solidification temperature of between −18° C. and +25° C., advantageously between −18° C. and +20° C., more advantageously between −18° C. and +15° C., and more advantageously between −18° C. and +8° C.

In the context of frozen products, the solvent advantageously has a solidification temperature of between −18° C. and 0° C., and more advantageously between −18° C. and −6° C.

In the context of refrigerated products, the solvent advantageously has a solidification temperature of between 0° C. and +25° C., advantageously between 0° C. and +20° C., more advantageously between 0° C. and +15° C., and more advantageously between 0° C. and +8° C.

Advantageously, the solvent has an approximate solidification temperature equal to −18° C., 0° C., +2° C., +5° C., +8° C., +15° C., +20° C., or +25° C.

According to the present invention, the solvent is advantageously transparent in the solid state in order to allow sharp optical acquisition of the visible shape formed by the coloured composition diffused in the solvent. Therefore, according to the present invention, the solvent is advantageously chosen from all solvents that are transparent in the solid state and that have a solidification temperature corresponding to the maximum temperature threshold required in the enclosure to be monitored.

The solvent may not be transparent in the solid state and, in such a scenario, the solute should be left to diffuse until the diffusion spirals touch or are flush with the transparent surface and create singular points there. The definition will be less detailed than with a transparent solvent giving singular points in 3D, but the 2D “signature” will be just as reliable and usable.

It is not possible to give a definition of the chemical class of a suitable solvent because it is its solidification temperature which will determine its suitability as a solvent, rather than its chemical class alone. Nevertheless, some can be cited by way of non-limiting illustrative examples.

Advantageously, the solvent is chosen from water, hydrocarbons, an oil, an alcohol, an aqueous electrolytic solution, and their mixtures.

Advantageously, of the hydrocarbons, the following can be cited: cyclohexane, benzene, xylene, and halogenated hydrocarbons such as 1,2-dichlorobenzene or carbon tetrachloride.

Advantageously, of the vegetable or plant oils, rapeseed oil, corn oil, olive oil and fish oils can be cited, used alone or in mixtures.

Advantageously, of the alcohols, the following can be cited: 1-octanol and ethylene glycol, for example. Advantageously, of the aqueous electrolytic solutions, the following can be cited: water/NaCl and water/MgCl solutions, for example. In the case of electrolytic solutions, and in particular water/NaCl solutions, the concentration of salt (for example NaCl) in the solution influences the solidification temperature. Therefore, a water/NaCl solution comprising 20% NaCl will have a solidification temperature of −20° C. A water/NaCl solution comprising 22% NaCl will have a solidification temperature of −19.2° C. A person skilled in the art knows how to adjust the concentration of salt in order to obtain the required solidification temperature while avoiding saturation of the solution with salt, which would lead to turbidity and therefore a lack of transparency. This type of solvent is therefore particularly advantageous in the context of the invention because it is economical and allows a specific solidification temperature to be chosen without being constrained by a restricted solvent list.

Advantageously, the solvent is chosen from the solvents cited in table 1 above, alongside their solidification/melting temperature.

Similarly, as indicated above, the choice of coloured composition (step b)) depends on the choice of solvent. The characteristics of the coloured composition are as defined above.

In particular, the coloured composition is advantageously a miscible liquid solution which is miscible in the solvent or a soluble solid which is soluble in the solvent, such as a solid in the form of powder, granules or a compacted tablet.

Advantageously, the colour of the coloured composition is visible in light or under IR radiation or UV radiation, and more advantageously visible in light or under UV radiation.

Advantageously, the colour of the coloured composition contrasts significantly with the colour of the solvent, so as to ensure good optical acquisition.

The coloured composition advantageously has a viscosity of between 1 and 1000 mPa·s, at ambient temperature (i.e., approximately 20° C.), in particular between 1 and 500 mPa·s, and more particularly between 1 and 250 mPa·s.

According to the invention, the choice of the coloured composition used in the device according to the invention is determined depending on the choice of the solvent used, and in particular the solidification temperature of this solvent.

For example, if in the device according to the invention the solvent used is water, the coloured composition may be a liquid or solid composition, not colourless in light or visible under UV or IR radiation, miscible/soluble in a temperature range comprising the value 0° C., and having a viscosity of between 1 and 1000 mPa·s, at ambient temperature (i.e., approximately 20° C.), in particular between 1 and 500 mPa·s, and more particularly between 1 and 250 mPa·s.

During step c), the liquid solvent is introduced into a receptacle having at least one transparent surface portion. In the context of the invention, the receptacle of the device is designed to receive the liquid solvent which will subsequently be solidified, and the coloured composition. Therefore, said receptacle comprises at least one opening allowing the solvent and then the coloured composition to be introduced.

The receptacle may be in any shape and made from any material and must have at least one transparent surface portion. Advantageously, the receptacle is totally transparent.

In the method for preparing the device according to the invention, it is possible to previously cool the liquid solvent during step d), in order to reduce the solidification time of the solvent once the coloured composition is introduced. This step also helps reduce the energy balance required to cool the solvent from ambient temperature to the solidification temperature. Indeed, the solidification of the solvent needs to take place before the coloured composition is totally diffused in the solvent. Therefore, if the diffusion speed is particularly high, the solvent needs to be cooled very quickly in order to reach the solid state before total diffusion, which can result in high energy costs.

Thus, during step d), the liquid solvent is eventually cooled to a temperature close to, greater than or equal to its solidification temperature, but without resulting in the solidification of the solvent. Advantageously, the liquid solvent is eventually cooled to a temperature 0.5° C. to 10° C. higher than the solidification temperature, and more advantageously 0.5° C. to 5° C. higher. For example, when water is used as the solvent, its temperature may be lowered from ambient temperature to 1° C. during step d). During step f), the water will then need to be cooled by approximately 1° C. to 0° C.

The cooling is advantageously carried out using refrigeration/freezing methods and devices known to a person skilled in the art. For example, the cooling may be carried out by conduction, convection and/or evaporation, for example using water or air as the refrigerant. The cooling may for example be carried out using a fast-cooling cell, an ice bath or cold bath, eutectic plates, or an industrial cooling system.

In the context of the invention, the cooling of step f) is carried out in order to obtain a transparent solid solvent (or solidified solvent). A person skilled in the art can use his or her general knowledge to determine which cooling method to use, depending on the solvent chosen.

During step e), the coloured composition is introduced into the receptacle comprising the liquid solvent and starts to diffuse in said solvent. A person skilled in the art will know how to incorporate the coloured composition in such a way as to avoid total diffusion upon incorporation. Step e) is stopped before total diffusion of the coloured composition, by cooling the obtained assembly during step f).

Thus, during step f), the obtained assembly is cooled in such a way as to solidify at least the liquid solvent in which the coloured composition has been partially diffused, so as to give the diffused coloured composition a specific shape that it can only keep by keeping the enclosure at a temperature below the solidification temperature of said solvent, thereby obtaining the solid solvent.

The cooling methods and devices that can be used are as defined above in relation to step d).

The present invention also relates to a control device for detecting a variation in temperature in an enclosure which can be obtained by the preparation method according to the invention.

### Method for Detecting a Variation in Temperature in an Enclosure

The present invention further relates to a method for detecting a variation in temperature in an enclosure, said method comprising the steps of:

i. Providing a device according to the invention as defined above, or a device which can be obtained by the method according to the invention as defined above;
ii. Placing said device in the enclosure;
iii. Inspecting the specific shape of the coloured composition that is partially diffused in the solvent.

The method according to the invention makes it possible to detect a variation in temperature in an enclosure, and advantageously to detect an increase in the temperature.

As indicated above, the increase in temperature may eventually be followed by a decrease in temperature. In this context, the temperature of the enclosure may increase, for example as a result of a technical fault in the temperature maintenance system, before decreasing to once more reach the initial temperature of the enclosure.

Advantageously, in the context of the invention, the variation in temperature characterises a break in the cold chain. Thus, the method according to the invention is advantageously a method for detecting a break in the cold chain.

Advantageously, the method according to the invention allows a variation in temperature of 1° C. or less to be detected. More advantageously, the method according to the invention allows a variation in temperature of between 0.1 and 1° C. to be detected.

Advantageously, the method according to the invention allows an increase in temperature of 1° C. or less to be detected. More advantageously, the method according to the invention allows an increase in temperature of between 0.1 and 1° C. to be detected.

In the context of the present invention, the enclosure is advantageously a preservation enclosure, advantageously for preserving temperature-sensitive products.

Advantageously, the enclosure is a primary, secondary or tertiary packaging, such as an isothermal packaging or a transport container such as a sea, air, road or space transport container; a transport facility such as a refrigerated lorry or a refrigerated trolley; a handling facility such as a clean room; or a storage facility such as a refrigerator, a cold room or a freezer.

For step i) of the method according to the invention, all the features of the device according to the invention and the method for preparing same are as defined above.

For step ii), a person skilled in the art will know how to place the device in the enclosure in such a way that it is subjected to the same temperature as the enclosure itself, along with products that it contains.

During step iii), the specific shape obtained by partial diffusion of the coloured composition in the solvent is inspected so as to identify a variation in temperature in the enclosure.

Advantageously, step iii) is carried out by image capture, then advantageously by locating minutiae.

More particularly, step iii) comprises at least the following sub-steps:
Capturing at least one reference image, at the time the device is placed in the enclosure;
Capturing at least one image to be compared, during or after the preservation of the products in the enclosure;
Comparing the reference images and the images to be compared in order to assess their degree of similarity.

The images may be captured by any devices and any methods known to a person skilled in the art, such as a camera, photographic equipment, a CCD sensor or a CMOS sensor, for example. The maximum resolution of the sensor used will determine the precision of the analysis of the characteristic singular points of the obtained diffusion profile.

Advantageously, the image capture device is a high-definition device in order to obtain the best possible image resolution, and thus the best possible comparison.

Advantageously, the image capture device according to the invention comprises a CCD (Charged Coupled Device) sensor or a CMOS (Complementary Metal Oxide Semiconductor) sensor.

If the coloured composition used is a composition coloured under UV or IR radiation, the device used for image capture will need to be designed to capture and transcribe this type of radiation.

Once the images have been captured, a set of singular points referred to as “minutiae” is advantageously identified. The minutiae are singular points, typical characteristics such as loops, forks, acute and obtuse angles, or very localised straight lines.

All these characteristics may be situated in planes Oxy and Ozy, then transcribed as coordinates such as the X-axis, Y-axis and angle in relation to the coordinate system. Pour each minutia “m”, there are two triplets: (x,y,α) in the plane O,x,y, connected to (z,y,β) in the plane O,z,y. The minutiae of the device during or after use (device S) are then compared with the minutiae of the initial device (device G). A person skilled in the art will be able to draw on his or her general knowledge in order to determine which comparison method to use.

For example, the specific shape obtained initially by the diffusion of the coloured composition in the solvent, in the initial device, referred to as “G” (standing for Genuine) can be described by a data series:

F(G)={m₁,m₂, . . . mₙ} where m₁^{G}=(x₁,y₁,α₁,z₁,β₁) . . . mₙ^{G}=(xₙ,yₙ,αₙ,zₙ,βₙ) [Math. 1]

Next, in order to compare the degree of similarity between the initial device G and the device to be compared S (standing for “under Scrutiny”) obtained after a certain time t, the same parameters can be identified as above:

F(S)={m₁,m₂, . . . mₙ} where m₁^{S}=(x₁,y₁,α₁,z₁,β₁) . . . mₙ^{S}=(xₙ,yₙ,αₙ,zₙ,βₙ) [Math. 2]

The two data sets in O,x,y and O,z,y in relation to devices G and S can then be analysed. For example, in order to compare devices G and S, all the coordinates of minutiae and the angular position must satisfy a degree of similarity that is subject to a tolerance threshold “Δ” that tends to zero or is strictly zero. For this purpose, the spatial distance (SD) between a minutia of device G and the same minutia of device S should verify the following inequation:

SD(m^{S},m^{G})—\sqrt{(xₙ^{S}−xₙ^{G})²+(yₙ^{S}−yₙ^{G})²}<Δ [Math. 3]

Naturally, with two identical data sets (<Δ), it can be concluded that the minutiae in devices G and S are coupled: no variation in temperature is detected. Otherwise, if device S is different from device G, a variation in temperature has taken place.

Another comparison technique according to the invention could be to measure the potential angular shift of the minutiae in S (αₙ^{S},βₙ^{S}) from G (αₙ^{G},βₙ^{G}).

According to the invention, the higher the number of minutiae inspected, the more precise the result obtained.

Advantageously, step iii) according to the invention makes it possible to detect a modification in the specific shape of the coloured composition that is partially diffused in the solvent, not visible on a macroscopic scale. More advantageously, step iii) according to the invention makes it possible to detect a microscopic modification of the specific shape of the coloured composition that is partially diffused in the solvent.

Advantageously, step iii) is carried out continuously or at regular intervals, and more advantageously in real time. This makes it possible to detect the moment, the place and the time period during which the variation in temperature has taken place, and therefore to determine the influence of this variation, for example on the products preserved in the enclosure.

The examples below are intended to illustrate the present invention in a non-limiting manner.

### DESCRIPTION OF THE FIGURES

FIG. 1 shows the device obtained at the time of injection of the ink (t₀) (FIG. 1A), then the diffusion of the ink in the water (t₁) (FIG. 1B).

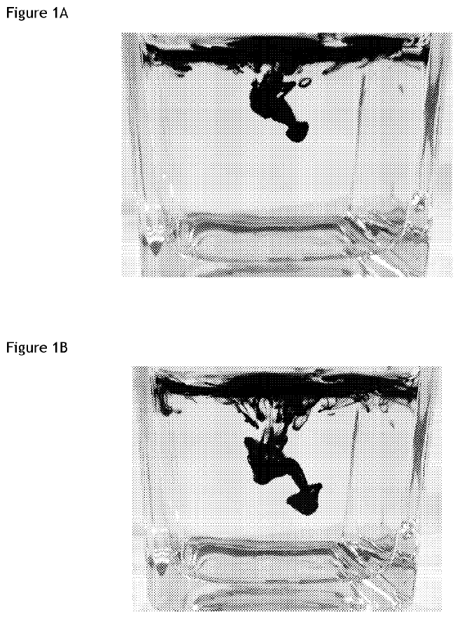

FIG. 2 shows the device obtained after freezing, i.e., after freezing the water (t₂) (face (0,x,y) on the left and adjacent face (0,z,y) on the right).

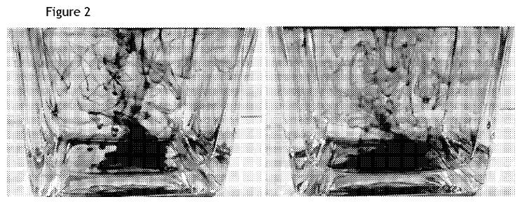

### EXAMPLES

### Example 1: Preparing a Device According to the Present Invention

Equipment:

A 27 cm³ transparent cube (sides measuring 3 cm);

Liquid water (solidification temperature=0° C. (33.8° F.));

A coloured composition comprising Waterman® blue ink for pens, produced mainly from the methyl violet 6B molecule having the raw chemical formula: C₂₄H₂₈ClN₃. Its viscosity is 1.11 mPa·s at ambient temperature and its radius is 112 angstroms; and

A cooling apparatus of the Peltier cooling unit type is used.

Protocol:

The 27 cm³ cube is filled with liquid water, then cooled to approximately +1° C.

Next, a drop of the coloured composition is deposited on the surface of the liquid water in the cube (t₀) and left to partially diffuse in the water for a few seconds (maximum 4 seconds) (t₁). As the ink molecules continue on their random path, the shape increases in complexity.

Finally, the assembly is cooled until the water freezes (t₂).

The freezing takes place before total diffusion of the coloured composition in the water.

### Example 2: Recording the Images of the Obtained Device

For this example, the device obtained in example 1 is used. Two images corresponding to two faces of the cube are recorded and give the coordinates (x,y,z) of the random “cloud” of ink in the solvent (water), which has just been solidified.

These images measure 3 cm×3 cm (1.18 sq inches) with a high resolution of 2000 pixels or 1693 dots per inch (DPI). The image is characterised as follows:
4 million pixels (2000×2000)
in 24-bit true colour: 12,000,000 octets or 11,444 Mo.

Therefore, with two photographed faces, the necessary memory space is ≈22 888 Mo.

This record is proof of the integrity of the frozen cube and will accompany the item from the time it leaves the food factory. It must remain the same from the producer to the final consumer, and the images taken initially will serve as a frame of reference for the comparison required at the end of the cold chain.

### Example 3: Comparison Procedure for Highlighting a Break in the Cold Chain

Images of the device obtained in example 1 are captured as described in example 2.

3.1. Characteristics of the Minutia

The minutiae are singular points, typical characteristics such as loops, forks, acute and obtuse angles, or very localised straight lines. All these characteristics may be situated in planes Oxy and Ozy, then transcribed as coordinates such as the X-axis, Y-axis and angle in relation to the coordinate system. Pour each minutia “m”, there are two triplets:

(x,y,α) in the plane O,x,y, connected to (z,y,β) in the plane O,z,y.

Overall, the solute cloud formed in the solvent, referred to as “G” (standing for Genuine) is described by a data series:

F(G)={m₁,m₂, . . . mₙ} where m₁^{G}=(x₁,y₁,α₁,z₁,β₁) . . . mₙ^{G}=(xₙ,yₙ,αₙ,zₙ,βₙ) [Math. 4]

Finally, the comparison is made between the image of cube G and another cube to be checked, referred to as “S” (standing for “under Scrutiny”). This cube S may be the same as G but corrupted by a break in the cold chain; or it may be another cube deliberately replaced by an ill-intentioned person. To this end, the same parameters are checked as above:

F(S)={m₁,m₂, . . . mₙ} where m₁^{S}=(x₁,y₁,α₁,z₁,β₁) . . . mₙ^{S}=(xₙ,yₙ,αₙ,zₙ,βₙ) [Math. 5]

The two data sets in O,x,y and O,z,y in relation to cubes G and S are analysed.

Put more simply, in order to check cubes G and S, all the coordinates of minutiae and the angular position must satisfy a degree of similarity that is subject to a tolerance threshold “Δ” that tends to zero or is strictly close to zero.

Therefore, the spatial distance SD must verify the following inequation:

SD(m^{S},m^{G})=\sqrt{(xₙ^{S}−xₙ^{G})²+(yₙ^{S}−yₙ^{G})²}<Δ [Math. 6]

Naturally, with two identical data sets, it can be concluded that the minutiae in cubes G and S are coupled: the inspected product is safe. If not, if S=G, a break in the cold chain has occurred during the lifetime of the product.

The same principle could be followed to measure the potential angular shift of the minutiae in S (αₙ^{S},βₙ^{S}) from G (αₙ^{G},βₙ^{G}).

Naturally, the higher the number of minutiae inspected, the more precise the result obtained.

In order to avoid false positives, an automated device and a software program will preferably overall similarity score: [Math. 7]

$$Score = \frac{k}{\frac{( number of minutiae {m}^{G} + number of minutiae {m}^{S} )}{2}}$$

Where:

k=number of identical minutiae according to the set threshold.

1. A control device for detecting a variation in temperature in an enclosure, the control device comprising a receptacle having at least one transparent surface portion comprising a solid solvent and a solidification temperature of which corresponds to a maximum temperature threshold required in the enclosure, wherein a coloured composition having a different colour from the solvent has been partially diffused before the solvent is solidified.

2. A device according to claim 1, wherein the solvent has a solidification temperature of between −18° C. and +25° C.

3. A device according to claim 1, wherein the receptacle comprises at least two surfaces having at least one transparent portion.

4. A device according to claim 1, wherein the solvent is chosen from water, hydrocarbons, an oil, an alcohol, an electrolytic solution, and their mixtures.

5. A method for preparing a control device for detecting a variation in temperature in an enclosure, comprising the following steps:
a) choosing a liquid solvent and a solidification temperature of which corresponds to a maximum temperature threshold required in the enclosure;
b) choosing a coloured composition having a different colour from the solvent;
c) introducing the liquid solvent into a receptacle having at least one transparent surface portion, the receptacle comprising at least one opening allowing the solvent and then the coloured composition to be introduced;
d) eventually cooling the liquid solvent;
e) introducing the coloured composition, and partially diffusing it in the liquid solvent, tbe coloured composition being a different colour from the solvent;
f) cooling so as to solidify at least the liquid solvent in which the coloured composition has been partially diffused, so as to give the diffused coloured composition a specific shape that it can only keep by keeping the enclosure at a temperature lower than the solidification temperature of the solvent.

6. A method according to claim 5, wherein the solvent chosen in step a) has a solidification temperature of between −18° C. and +25° C.

7. A method according to claim 5, wherein the receptacle comprises at least two surfaces having at least one transparent portion.

8. A method according to claim 5, wherein the solvent chosen in step a) is chosen from water, hydrocarbons, an oil, an alcohol, an electrolytic solution, and their mixtures.

9. A method according to claim 5, wherein a viscosity of the coloured composition chosen in step b) is of between 1 and 1000 mPa·s at ambient temperature.

10. A method for detecting a variation in temperature in an enclosure, the method comprising at least the steps of:
i. providing a device according to claim 1 or a device which can be obtained by the method according to claim 5;
ii. placing the device in the enclosure;
iii. inspecting the specific shape of the coloured composition that is partially diffused in the solvent.

11. A method according to claim 10, wherein step iii) is carried out by image capture, then by locating minutiae.

12. A method according to claim 10, wherein step iii) is carried out continuously, in real time.

13. A method according to claim 10, wherein the enclosure is a preservation enclosure, for preserving temperature-sensitive products.

14. A method according to claim 10, wherein the enclosure is a primary packaging, a secondary packaging, a tertiary packaging, a transport facility, a handling facility, or a storage facility.

15. A device according to claim 1, wherein the solid solvent is transparent.

16. A device according to claim 1, wherein the solvent has a solidification temperature of between −18° C. and +20° C.

17. A device according to claim 1, wherein the solvent has a solidification temperature of between −18° C. and +15° C.

18. A device according to claim 1, wherein the solvent has a solidification temperature of between −18° C. and +8° C.

19. A device according to claim 1, wherein the receptacle comprises at least three surfaces having at least one transparent portion.

20. A device according to claim 1, wherein the receptacle is totally transparent.
